(19) United States
(12) Patent Application Publication
(10) Pub. No.: US 2015/0302357 A1
(43) Pub. Date: Oct. 22, 2015

(54) METHOD AND SYSTEM FOR EVALUATING USER ASSERTIONS

(71) Applicant: ROHIT CHANDRA, SUNNYVALE, CA (US)

(72) Inventor: ROHIT CHANDRA, SUNNYVALE, CA (US)

(21) Appl. No.: 14/690,319

(22) Filed: Apr. 17, 2015

Related U.S. Application Data
(60) Provisional application No. 61/981,693, filed on Apr. 18, 2014.

(51) Int. Cl. G06Q 10/10

(52) U.S. Cl. CPC G06Q 10/1053

(57) ABSTRACT

The various embodiments herein disclose a method and system for enabling users to make assertions of suitability and have other users evaluate those assertions. According to an embodiment of the present invention, the method comprises steps of receiving an application along with a guarantee from an applicant. Herein, the application corresponds to one or more requirements; authenticating, by a guarantee verification module, the guarantee received from the applicant; evaluating, by an evaluation module, the suitability of the application with respect to the requirement; and deducting, by a deduction module, portion of the guarantee received from the applicant, if the application matches requirement, otherwise rejecting the application along with forfeiting the guarantee.

### RELATED APPLICATIONS

The present application claims the benefit of the filing date of U.S. Provisional Patent Application with Ser. No. 61/981,693, filed on Apr. 18, 2014.

### FIELD OF TECHNOLOGY

The present invention relates generally to web-based user services. More particularly, the present invention relates to methods and systems that enable users to make assertions and have other users evaluate those assertions.

### BACKGROUND

An overwhelming number of users are contending to be suitable for a plethora of different tasks and activities. However despite the availability of a large number of tools, and methodologies there is still a lot of effort that goes into evaluating the contending users' assertions. The assertions need to be evaluated for quality, accuracy, consistency, applicability and suite of similar characteristics. Given the amount of effort that is required in this evaluation process, it leaves a lot to be desired when it comes to efficiencies in the system.

A wealth of tools and information is available on the Internet, and particularly that segment of the Internet referred to generally as the World Wide Web. However, despite a lot of innovation in web-based tools and methods, there is still no clear, easy or automated way for one user to evaluate another user's assertion about his/her ability, suitability without expending considerable amount of time, effort and energy. Perhaps even more frustrating is the lack of web-based tools to attach significant weight or importance to the asserting user's assertion of their ability, suitability.

An example of a user's assertion might be their suitability for an open job that an employer, company, or headhunter is recruiting for.

Typically, when a position opens up at an employer, or a company: the hiring manager prepares a job description. The job description usually includes a list of desired skills, characteristics in the person to be hired into that role, and a list of responsibilities to be fulfilled once the person gets hired.

The job description will often include some information about the company. This information is commonly added by someone working for the Human Resources Department. Often this is common for all jobs being posted by that employer. Along with this, there may be a slew of other information that the Job Description will have such as Required Educational Qualifications, years of experience, physical location that the new employee would be working at, a salary range, and other miscellaneous information.

Once this Job Description has been collated and formulated it is ready to be advertised and shared with the outside world. At which point the hiring company may choose to run classified advertisements, post it on their own website, and promote it in a variety of different ways so as to be able to locate a person who has the matching skillset and is a suitable hire to fill that role.

Often times, third party recruiting companies are utilized by the hiring company to go and search for candidates with matching skill sets. To do this—the recruiters, sometimes also called sourcers, will try and find resumes in existing collections/databases of resumes. These recruiters routinely do not possess an understanding of what the job entails, and therefore what skills the person they are looking for must ideally possess—which is why they go back to the Job Description and do a best-guess match.

The industry as a whole recognized this shortcoming, and today numerous tools exist that allow recruiters to match key-words on candidate resumes with key-words on the Job Description and make match-ups.

More sophisticated and advanced tools are also in existence, some of which rely on Artificial Intelligence, to try and make a match between matching candidate profiles and the current Job Description. The quality of these candidate-job matching may be debatable, but that is not the subject for this document.

Typically recruiters have to read through a pool of candidate resumes and short-list potentially matching resumes. Once a recruiter gets a list of matching resumes: the recruiter now needs to ascertain if the candidate is available and/or looking for a new job. This involves the recruiter, or a junior administrative person making first contact with the candidate: to determine availability, salary expectations, location desired—and more or less of other matching criterion. If there is a sufficient match, then a follow-up call is scheduled—typically with the recruiter, or a senior recruiter.

Thereafter a recruiter will typically have a conversation with the candidate to further qualify the candidacy. If the recruiter believes the candidate is qualified, then the resume gets forwarded onto the Hiring Manager. In most scenarios, the resume will need to be reviewed and approved by additional people such as an Account Manager, a Senior Recruiter, an HR Manager, or what have you: before it makes its way onto the Hiring Manager.

The Hiring Manager in turn reviews a list of resumes from the recruiter and then selects a subset of those candidates to have a conversation/interview with.

This is a sieving/filtering process where a significant portion of candidates get dis-qualified, or are determined not to be matches. Expending this energy causes significant cost to the recruiting entity—which could be the employer themselves, or it could be a recruiting company or such, or both.

Thus, there is a compelling need for a tool, a system, a product, and a method to easily, quickly, and at a little, or no cost, identify matching candidates. Essentially we need an efficient method, or an efficient system, or an efficient product that enables some users to make assertions of their suitability and have other users evaluate those assertions, and potentially make—business, personal, life, career etc.—decisions based upon the validity/invalidity, or accuracy of those assertions.

The above mentioned shortcomings, disadvantages and problems are addressed herein and which will be understood by reading and studying the following specification.

### SUMMARY

The various embodiments herein disclose a method and system for enabling the assertions of users of a user assertion system. Accordingly a user assertion service includes a one or more web pages providing users with a mechanism to make assertions regarding their suitability for one or more requirements. Furthermore, an asserting user may have the ability to provide a guarantee, or a penalty structure for failed, or disqualified/invalidated assertions. Other evaluating users then have the ability to evaluate the assertions for validity, quality, accuracy etc. Evaluating users have the ability to apply penalties on the guarantee.

According to an embodiment of the present invention, a method for evaluating user assertions for suitability is disclosed. The method may include receiving an application along with a guarantee from an applicant. Further, the method may include evaluating the suitability of the application with respect to the one or more requirements. The method may further determine the outcome of the evaluation of the application with respect to the one or more requirements, and modifying the guarantee received based on the outcome of the evaluation of the application.

The method further comprises of authenticating the guarantee received from the applicant device. According to the present method the guarantee received from the applicant device is one or more of monetary, commodity, bitcoin, service, virtual currency, loyalty program, reward points etc. In an embodiment of the invention the guarantee amount can be determined algorithmically by factoring in the compensation, future expectations, historical performance: of the applicant, evaluator, third party, or similar data variables.

According to an embodiment of the present invention, the modifying of the guarantee comprises of forfeiting a portion of the guarantee if the outcome of the evaluation suggests that the application does not match with the requirements of the evaluator. According to another embodiment of the present invention, modifying of the guarantee comprises of deducting a portion of the guarantee—so as to reduce the guarantee amount—if the outcome of the evaluation suggests that the application does match with the requirements of the evaluator device. The method further comprises of rewarding any or all of the applicant, evaluating user, evaluator and the assertion service in the case of a successful match.

According to an embodiment of the present invention, the method further comprises the ability for any subset of the applicant, the evaluator, and the entities they represent to be able to rate the others. The method further comprises of enabling additional communication with the applicant device if the evaluation determines that the application matches the requirements. The method further comprises of storing, by a storage module, the evaluation of the applications with respect to the one or more requirements.

According to another embodiment of the present invention, a system for evaluating user assertions comprising a processor that processes a document hosted on an internet connected server, and a receiver module that receives an application along with a guarantee from a candidate device. Further, the system may include a guarantee verification module that authenticates the guarantee received from the applicant device. Furthermore, the system may include, an evaluation module that evaluates the suitability of the application with respect to the one or more requirements. The evaluation module determines the outcome of the evaluation of the application with respect to the one or more requirements, and a deduction module that modifies the guarantee received based on the outcome of the evaluation of the application. Further the system may include a memory for storing the application.

According to an embodiment of the present invention, the system further comprises of a guarantee verification module that authenticates the guarantee received from the applicant device wherein the guarantee received from the applicant device is one or more of monetary, commodity, bitcoin, service, virtual currency, loyalty program, and reward points. According to an embodiment of the invention the guarantee amount can be determined algorithmically by factoring in the compensation, future expectations, historical performance: of the applicant, evaluator, third party, or similar data variables.

According to an embodiment of the present invention, the modification of the guarantee comprises the deduction module forfeits a portion of the guarantee if the outcome of the evaluation suggests that the application does not match with the requirements. According to another embodiment of the present invention, the modification of the guarantee comprises the deduction module deducts a portion of the guarantee if the outcome of the evaluation suggests that the application does match with the requirements.

According to an embodiment of the present invention, the method further comprises of rewarding any combination of the applicant, evaluating user, evaluator, and the assertion service in the case of a successful match. The method further comprises the ability for a subset of the applicant, the evaluator, and the entities they represent to be able to rate the others.

The evaluation module may enable additional communication with the applicant device if the evaluation suggests that the application matches the requirements. The system further comprises of a storage module that stores the evaluation of the applications with respect to the one or more requirements.

In yet another embodiment of the present invention, a computer-program product for evaluating user assertions, the computer-program product comprising a non-transitory computer-readable medium having instructions thereon, when executed enables an assertion system to perform steps of receiving, by a receiver module, one or more requirements, receiving, by the receiver module, application along with a guarantee from a candidate device, evaluating, the suitability of the application with respect to the requirement, determining the outcome of the evaluation of the application with respect to the one or more requirements, and modifying, by a deduction module, the guarantee received based on the outcome of the evaluation of the application.

According to an embodiment of the present invention, the computer-program product comprises of authenticating, by a guarantee verification module, the guarantee received from the applicant device, wherein the guarantee received from the applicant device is one or more of monetary, commodity, bitcoin, service, virtual currency, loyalty program, and rewards points. According to an embodiment of the invention the guarantee amount can be determined algorithmically by factoring in the compensation, future expectations, historical performance: of the applicant, evaluator, third party, or similar data variables.

According to an embodiment of the present invention, the modifying of the guarantee comprises of forfeiting a portion of the guarantee if the outcome of the evaluation determines that the application does not match with the requirements. According to another embodiment of the present invention, the modifying of the guarantee comprises of deducting a portion of the guarantee if the outcome of the evaluation determines that the application does match with the requirements.

The computer-program product further comprises of enabling additional communication with the applicant device if the evaluation suggests that the application matches the requirements.

The computer-program product further comprises of rewarding any combination of the applicant, evaluating user, evaluator, and the assertion service in the case of a successful match. The method further comprises the ability for a subset of the applicant, the evaluator, and the entities they represent to be able to rate the others.

The computer-program product further comprises of storing, by a storage module, the evaluation of the applications with respect to the one or more requirements.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a schematic flow chart illustrating a method for evaluating user assertions, according to an embodiment of the present disclosure;

FIG. 2 is a schematic block diagram illustrating a system for evaluating user assertions, according to an embodiment of the present disclosure;

FIG. 3 is a schematic network architecture illustrating a system for evaluating user assertions, according to an embodiment of the present disclosure;

FIG. 4 is a schematic block diagram illustrating a graphical user interface (GUI) with various options for a user, according to an embodiment of the present disclosure; and

FIG. 5 is a schematic table illustrating an exemplary evaluation database for storing evaluation data, according to an embodiment of the present disclosure;

FIG. 6 is an exemplary block diagram for a job description requirements, according to an embodiment of the present disclosure, and

FIG. 7 depicts a network architecture illustrating a system for evaluating user assertions, according to another embodiment of the present disclosure.

Although specific features of the present invention are shown in some drawings and not in others. This is done for convenience only as each feature may be combined with any or all of the other features in accordance with the present invention.

### DETAILED DESCRIPTION OF THE EMBODIMENTS

### Glossary

Requirement: is a desired characteristic to fulfill a perceived need of another user or entity.

Assertion: a claim of matching suitability for one or more requirements.

Applicant: is a user who asserts his, or her, suitability as a potential match for one or more requirements. If the applicant is asserting suitability on behalf of another entity (such as a company), he or she is used as a proxy for that entity. Also known as a candidate.

Candidate: is a user who asserts his, or her, suitability as a potential match for one or more requirements. If the candidate is asserting suitability on behalf of another entity (such as a company), he or she is used as a proxy for that entity. Also known as an applicant.

Application: is a submission made by, for, or on behalf of an Applicant pertaining to their suitability for one or more requirements.

Evaluator: determines the suitability of an application for a potential match.

Evaluating user: is a user who determines the suitability of an application for a potential match (i.e. an exemplary instance of an evaluator in one embodiment.) If the evaluating user is representing some entity (such as a company), then evaluating user or evaluator are used as a proxy for that entity.

Guarantee: is a surety provided by the applicant.

Hiring Manager: is an exemplary evaluator of an instance embodiment.

Candidate device: is an internet connected device being used by, or on behalf of a candidate at a point in time.

Applicant device: is an internet connected device being used by, or on behalf of an applicant at a point in time.

Evaluator device: is an internet connected device being used by, or on behalf of an evaluator at a point in time.

The various embodiments herein disclose a method and system for enabling users to make assertions and have other users evaluate those assertions. In the following detailed description of the embodiments of the invention, reference is made to the accompanying drawings that form a part hereof, and in which are shown by way of illustration specific embodiments in which the invention may be practised. These embodiments are described in sufficient detail to enable those skilled in the art to practise the invention, and it is to be understood that other embodiments may be utilized and that changes may be made without departing from the scope of the present invention. The following detailed description is, therefore, not to be taken in a limiting sense, and the scope of the present invention is defined only by the appended claims.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features, integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Described herein are various aspects related to users making assertions with regard to their suitability for one or more requirements, and have other users evaluate those assertions. The present invention describes effective methods for receiving requirements, applications from the applicants along with a guarantee, and evaluating the application of the applicants.

Applicant, candidate, and candidate user are used interchangeably in this specification.

In an embodiment of the present invention, the assertion may be received for any of: application for a job, a supply-demand system, a musician audition, an acting audition, funding for an entrepreneur, business development leads, matchmaking, and dating based on one or more requirements. Thus, if the one or more requirements correspond to finding a female partner with age ‘X’ for ‘dating’ then the application may correspond to a male applicant with the same age ‘X’. Similarly, if the requirement corresponds to a human resource for finding a suitable candidate for a particular job then the assertion may be received from the suitable candidate for the job. It may be appreciated by a person skilled in the art that the requirements may be posted for any particular area of interest and the assertion in the form of a guarantee may be received from one or more applicants based on such requirements. Further, it may be appreciated that the present invention is not restricted to the specified areas for implementation thereof. Further, the present invention may be implemented in many more areas without departing from the scope of the invention.

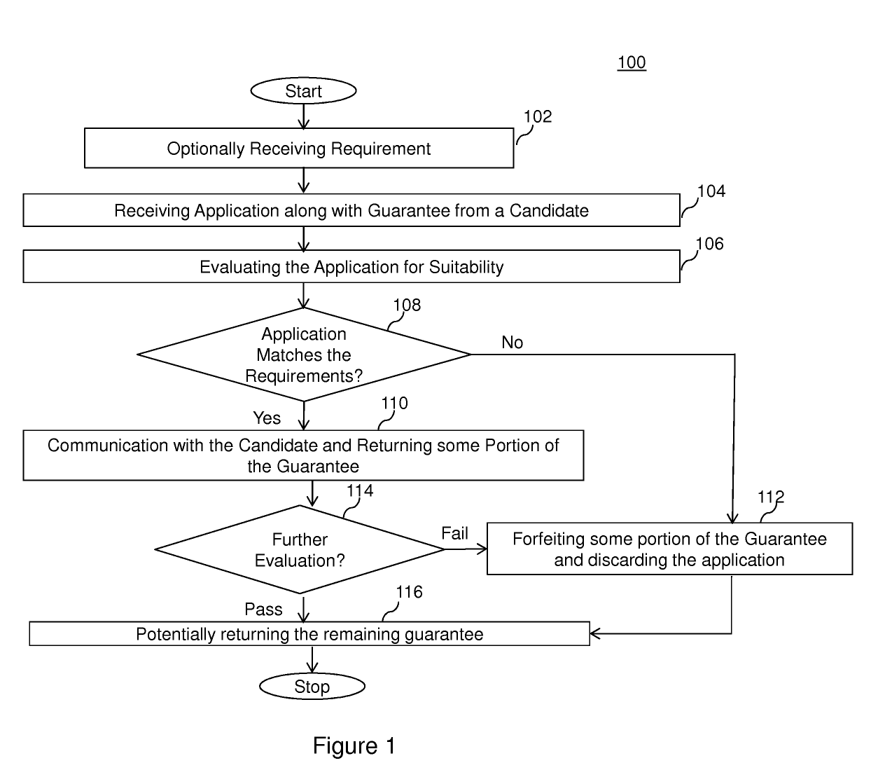

FIG. 1 is a schematic flow chart illustrating a method for evaluating user assertions for suitability, according to an embodiment of the present disclosure. As depicted, at step 102, the method comprises a step of receiving one or more requirements from a user. The user may be an evaluator (an evaluating user) himself, or maybe some other user who has been entrusted with the responsibility of locating/identifying/enlisting/recruiting matching user(s) that satisfy some subset of those requirements. The one or more requirements of the evaluator can be received from (i) the evaluator device, or (ii) some other internet connected device.

In an alternate embodiment, the method 100 may not include the step 102 of receiving the one or more requirements. In yet another embodiment, the one or more requirements may not even be available on the Internet. In such an instance embodiment, the one or more requirements however could still be uniquely located by a set of identifiers.

In an embodiment of the present invention, the evaluator may be provided with a Graphical User Interface (GUI) to fill in information corresponding to his/her requirements and thus, the evaluator device may be accessed by the evaluator and requirements are received from the evaluator himself. In another embodiment of the present invention, the requirements may be received from a third party such as a recruiter, or a hiring manager, or someone else representing the evaluating user's set of requirements. In another embodiment, the one or more requirements may be received from another website: by scraping from there, by using some API, by getting a submission, or any of a plethora of alternate means. In another alternate embodiment, the third party may include an intermediate person who can act between the evaluator and an applicant. Herein, the third party can receive one or more requirements from a user (such as an evaluator) who is in need of the matching user and who possesses/meets the one or more requirements of the evaluator.

In an embodiment of the present invention, the method receives the one or more requirements of the evaluator can be present within the evaluator device. A person having ordinarily skilled in the art can understand that a receiver module can be used to receive the one or more requirements without departing from the scope or spirit of the invention.

In an embodiment of the present invention, the one or more requirements can be, any of, but are not limited to, a human resource application for a job, supply-demand system, musician audition, acting audition, funding for an entrepreneur, business development leads, and the like, without departing from the scope of the invention. In an embodiment of the present invention, the one or more requirements can be displayed through a display module so that it can be viewed by one or more other users.

Further, at step 104, the method comprises step of receiving an application along with a guarantee from a candidate device. Once the one or more requirements are received, such requirements can be displayed to one or more candidates. One or more candidates can view the displayed one or more requirements through the display module of a candidate device and if they wish to assert their suitability, then they can send their applications by applying for such requirements. In an embodiment, the method 100 may receive the application sent from the candidate device. Along with the application, the method may receive (through the receiver module) a guarantee. In an alternate embodiment, the one or more requirements may not even be on the Internet, and the method 100 may receive the Application referenced by a unique set of identifiers. In yet another embodiment, the Application may be received on behalf of a candidate.

In an embodiment of the present invention the guarantee received from the applicant device is one or more of, but not limited to, monetary, commodity, bitcoin, virtual currency, service, and the like, and a person having ordinarily skilled in the art can understand that any other guarantee can be used for assertion of the candidate without departing from the scope or spirit of the invention. The guarantee submitted by the candidate demonstrates that the candidate is interested in the requirement posted, and asserts herself/himself (or the entity s/he represents) to be a suitable match.

In an embodiment of the present invention, the method also comprises the step of authenticating, by a guarantee verification module, the guarantee received from the applicant device. The guarantee received by the receiver module can be sent to the authentication module that checks the authenticity of the received guarantee. In an embodiment of the present invention, the authentication module can authenticate the guarantee on its own. In another embodiment of the present invention, the authentication module can communicate with a third party authentication server to authenticate the guarantee asserted by the candidate device.

Further, at step 106, the method comprises the step of evaluating, such as by an evaluation module, the suitability of the application with respect to the one or more requirements. Once the authentication module acknowledges that the guarantee asserted by the candidate device is valid, the candidate application can be sent to the evaluation module. The evaluation module receives the application of the candidate to evaluate the application in light of the one or more requirements.

Once the application (from the candidate device) is received, the evaluator matches the application of the candidate to identify whether there is a potential match, as depicted through step 108. The evaluation module can match for all the requirements, or a subset of the requirements, with the application of the candidate device to determine how suitably the application matches with the requirements.

Further, the method comprises the steps of determining the outcome of the evaluation of the application with respect to the one or more requirements. Once the matching is done, the evaluation module obtains an outcome of the matching. The outcome of the evaluation of the application may be determined. The outcome of the evaluation may depict whether the application of the candidate matches the requirements of the evaluator or not. And further, the degree or level of match between the application and the requirements may identify that how much the application is matching with the requirements of the evaluator. Based on the outcome of the identified evaluation, a decision can be made whether to proceed further with the application or to discard the application.

If the application matches the requirements of the evaluator, then at step 110, communication with the applicant/candidate may happen. Further, a pre-determined portion of the guarantee can also be returned to the applicant upon selecting the application. If the application does not match with the requirements of the candidate, then at step 112, the application of the candidate can be discarded and entire guarantee can be forfeited.

Further the method comprises the step of modifying, by a deduction module, the guarantee amount received, based on the outcome of the evaluation. Based on the decision received from the evaluation module, the deduction module can modify the guarantee of the candidate device. In an embodiment of the present invention, if the outcome of the evaluation suggests that the application does not match with the requirements of the evaluator device, the deduction module can forfeit the entire guarantee, at step 112. (In an alternate embodiment, the deduction module may choose to forfeit only a portion of the guarantee.) In another embodiment of the present invention, if the outcome of the evaluation suggests that the application does match with the requirements of the evaluator device, then the deduction module can deduct a portion of the guarantee and return the remaining guarantee to the candidate device, and proceed with next step 110. (In an alternate embodiment, the deduction module may return the entire guarantee upon a suitable match).

Further, the method comprises the step 110 for enabling additional, communication with the applicant if the evaluation determines that the application matches the one or more requirements of the evaluator device. Once the deduction module deducts a portion of the guarantee, then the evaluator device and candidate device can be notified of additional communication. In an alternate embodiment, the deduction of the guarantee may happen after the communication with the Applicant. Regardless of the order in which the communication happens, or who initiates the communication, it does not deviate from the spirit and scope of the present invention. In an embodiment of the present invention, the notification for communication can be sent in the form of, but not limited to, a pop up message on the display of the evaluator device, an alert, an email, a SMS, an audio call, and the like. At step 110, the evaluator may communicate with candidate using any communication method that may include, but not limited to, audio call, video call, face-to-face meeting, email, SMS, VOIP call, Skype, and the like for proceeding further with the communication.

In an embodiment of the present invention, the application of the candidate from the candidate device can be evaluated iteratively for different requirements. Based on the iterative evaluation, the guarantee can also be iteratively deducted and remaining guarantee can be returned to the candidate device. At step 114, it is determined whether the suitability match between the evaluator and the candidate is successful or not. If yes, then the process moves to step 116, where the remaining guarantee can be returned to the candidate. If no, then the process moves to step 112, and the remaining guarantee can be forfeited along with discarding the application of the candidate.

In an embodiment of the present invention, if the suitability match between the candidate and the evaluator is ultimately determined to be a good match, then a reward may be given to the candidate for identifying and asserting their suitability by submitting an application. In another embodiment, a reward may be given to the evaluating service for enabling this method. In yet another embodiment, a reward may be given to the evaluating user or the evaluator.

The reward will typically be comprised of one or more types of: monetary, commodity, bitcoin, service, virtual currency, loyalty program, reward points etc.

Further the method comprises the step of storing, by a storage module, the evaluation of the applications with respect to the one or more requirements of the evaluator device. The evaluation data related to the one or more candidates can be stored in the storage module so that if any of the candidate re-applies for any of the requirements of the evaluator, then the evaluation outcome of the candidate can be considered again to identify whether the application can be considered or not. In an embodiment of the present invention, the storage module can be any of, but not limited to, internal storage device, external storage device, storage present on a cloud network, and the like.

The present method can be implemented to search for a suitable candidate who can assert his/her candidacy for a requirement posted by, or on behalf of any evaluator, wherein the candidate can show that his/her interest and suitability for the particular requirement is genuine. The assertion made by the candidate in the guarantee can be refunded to the candidate as the application for the requirement matches, and thereby making the assertion process simple and effective.

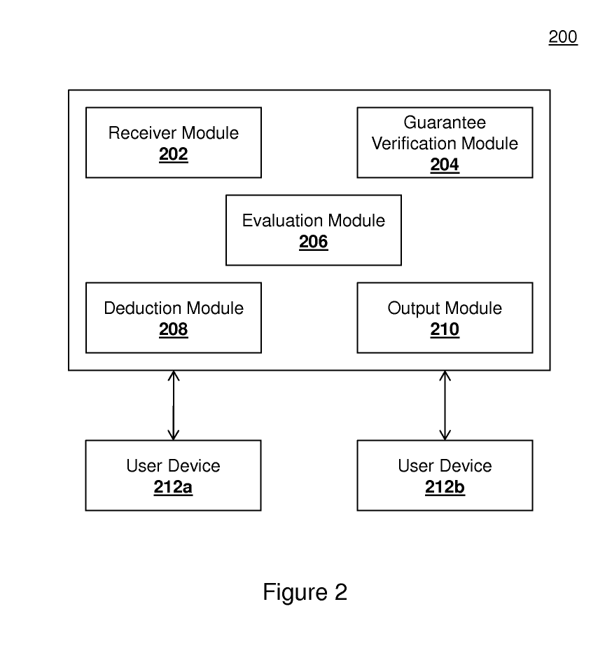

FIG. 2 is a schematic block diagram 200 illustrating a system for evaluating user assertions for suitability, according to an embodiment of the present disclosure. According to FIG. 2, the system 200 comprises of a receiver module 202 that receives one or more requirements from, or on behalf of, an evaluator device, applications from one or more candidate devices for the one or more requirements along with a guarantee in the form of an assertion. In one embodiment of the present invention, the receiver module 202 can be present with a third party user. In another embodiment of the present invention, the receiver module 202 can be present with any other device for receiving information corresponding to the requirements of either the evaluator or the third party user using, any of, but not limited to, wireless network, cloud computing, as a software installed on the user device, and the like. A person ordinarily skilled in the art can understand that the receiver module 202 can be used to receive the one or more requirements of the evaluator without departing from the scope or spirit of the invention. The system 200 further comprises of a guarantee verification module 204 that can authenticate the guarantee provided by the candidate device and determine the validity thereof.

The system 200 further comprises of an evaluation module 206 that can evaluate the application received from candidate device upon successful authentication of the guarantee provided by the candidate device. The evaluation module 206 can match up the application with the one or more requirements and can provide an outcome whether the application matches with the requirements or not. The system 200 further comprises of a deduction module 208 that deducts at least a portion of the guarantee upon identifying that the application matches one or more requirements of the evaluator. In an embodiment of the present invention, the deduction module 208 can deduct the portion of the guarantee every time the evaluation module 206 provides the outcome upon evaluating the application.

Further, the system 200 can comprise of an output module 210 that can provide the outcome and the details regarding the guarantee and the application to the evaluator and the candidate. Further the system 200 can comprise of a storage module (not shown in the figure) that can store the evaluation outcomes for future reference. Further, as depicted, the system 200 may comprise a user device 212a and a user device 212b that may include the candidate device and the evaluator device for interacting with the system 200.

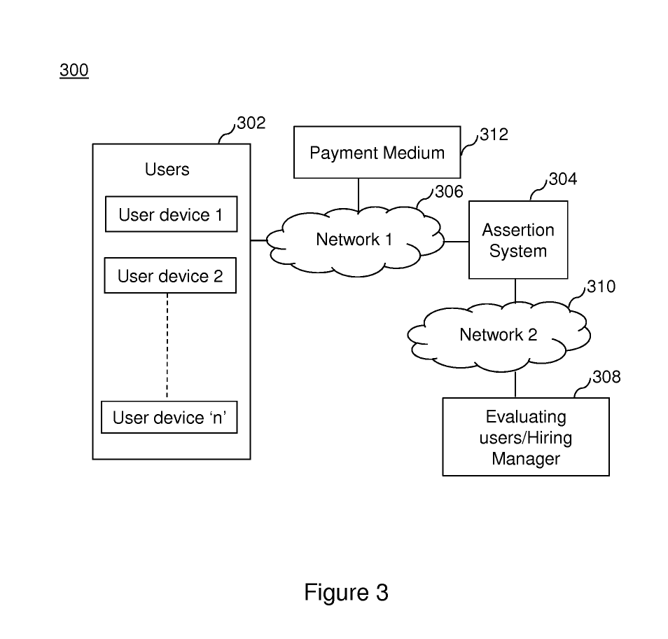

FIG. 3 is a schematic network architecture 300 illustrating an exemplary system for evaluating user assertions for suitability, according to an embodiment of the present disclosure. According to the FIG. 3, the network 300 comprises of users 302, an assertion system 304, a first network 306, an evaluating user 308, a second network 310, and a payment medium 312. The users 302 can comprise of one or more users as depicted from user device 1, user device 2, . . . user device n that are submitting applications.

The architecture further comprises of the evaluating users or hiring managers 308 who are posting the requirements on a website so that applicants can see the posting and apply for the requirements. In an embodiment of the present invention, the hiring managers can be accessing the device from their location and can post the requirement on the website. In an alternate embodiment, the requirements can be posted by another user on behalf of a Hiring Manager. The network architecture 300 can further comprise of the assertion system 304 that can perform receiving the requirements and the application along with the guarantee, authenticating the guarantee, evaluating the application and providing an outcome to the hiring manager about the evaluation of the application. The users 302 can communicate with the assertion system 304 via the first network 306, whereas the hiring managers 308 can communicate with the assertion system 304 via the second network 310.

In an embodiment of the present invention, the first network 306 and second network 310 can be any of, but not limited to, local area network (LAN), wide area network (WAN), and the like, wherein the WAN can include but not limited to, wireless network, cloud network, internet, and the like. The person having ordinarily skilled in the art can understand that any of the known network technology can be used for establishing communication between the users 302 and the assertion system 304, and between the hiring managers 308 and the assertion system 304 without departing from the scope of the invention.

In another embodiment of the present invention, the first network 306 and the second network 310 can be one and the same.

In another embodiment of the present invention, the assertion system 304 can be part of the hiring managers 308. In another embodiment of the present invention, the assertion system 304 may be a part of a third party, such as a headhunter agency, that can interact with the hiring managers 308. In another embodiment of the present invention, the assertion system 304 can be present on the cloud network. The assertion system 304 can be embedded in the network architecture to easily facilitate the evaluation of requirements and the application without departing from the scope of the invention.

The network architecture 300 further comprises of the payment medium 312 that can authenticate and handle the guarantee from the users 302 to the assertion system 304. The payment medium 312 can be connected to the first network 306 so that the authentication process of the guarantee becomes easy.

According to the present network architecture, the hiring managers 308, or another user on their behalf, can post a requirement for a job on the website over the second network 310 and that can be presented to users through the assertion system 304. The users 302 can view the job requirement posted by the hiring managers 308. Upon finding that their qualification is suitable for the job requirement, the users 302 can assert the suitability by submitting their application along with a guarantee to the system 304 over the first network 306. The payment medium 312 can authenticate the guarantee and once the assertion system 304 receives the acknowledgement from the payment medium 312, the evaluation of the application can be initiated.

If the assertion system 304 identifies that the application matches the requirement posted by the hiring managers 308, then the assertion system 304 can deduct a portion of the guarantee payment and refund it to the users 302. The assertion system 304 also informs the hiring managers 308 that the application of the selected user is suitable for the job position and thus allows communication with the selected user (applicant).

If the assertion system 304 identifies that the application does not match the requirement posted by the hiring managers 308, then the assertion system 304 can forfeit the entire guarantee and discard the application of the user. The assertion system 304 can also inform the user about unsuccessful application for the job posting. In an alternate embodiment, the assertion system may forfeit only a portion, or not forfeit any guarantee submitted by the Applicant.

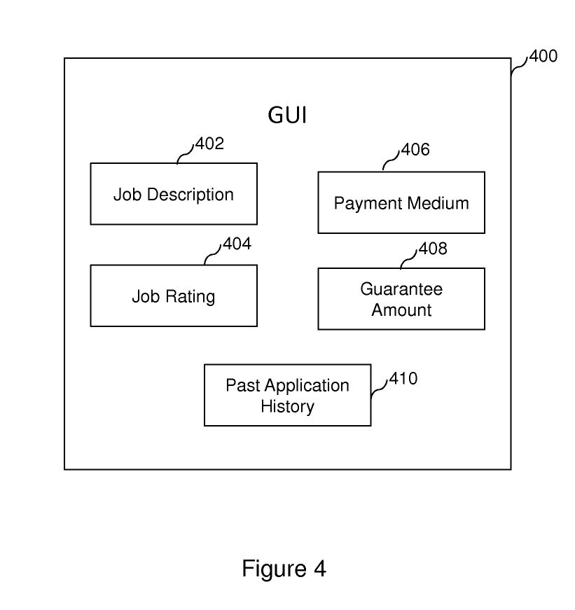

FIG. 4 is a schematic block diagram 400 illustrating a graphical user interface (GUI) with various options for a user, according to an embodiment of the present disclosure. In an embodiment of the present invention, the block diagram 400 of the graphical user interface (GUI) can be part of the output module (such as the output module 210, as described in FIG. 2) of the assertion system. In another embodiment of the present invention, the GUI can be part of the display of the candidate device and/or the evaluator device.

The GUI 400 comprises of a job description 402, job rating 404, payment medium 406, a guarantee amount 408, a past application history 410. The GUI can be displaying the information on a website to the candidate as well as to the evaluator. The job description 402 can be the description of the requirements posted by the evaluator/hiring managers that includes requirements for a job. The candidate can view the job requirements to assess whether his qualifications match the requirements or not.

The GUI 400 further comprises of the job rating 404 that can indicate the ratings for the particular job. In an embodiment of the present invention, the ratings could be algorithmically determined by factoring in a weighted plurality of factors such as responsiveness, hiring ratio, past applicant inputs, accuracy, forfeit percentage, company reputation, hiring manager reputation and like. In an embodiment of the present invention, the rating 404 can be made visible to all the users who visit the web page containing the job requirement post. In another embodiment of the present invention, the rating 404 can be made visible only to users who register themselves with the website and sign in from their account.

The GUI 400 further comprises of the payment medium 406 that provides clear information to the candidate about the guarantee modes available, and the amount to be submitted to apply for the current job requirement.

The GUI 400 further comprises of the guarantee amount 408. The guarantee amount 408 information can be displayed to the candidate so that the candidate is aware of the guarantee amount that he/she needs to pay before applying for the job posting. In an embodiment of the present invention, the guarantee amount 408 can be decided by the hiring managers. In another embodiment of the invention the guarantee amount can be determined algorithmically by factoring in the wages, future expectations, historical performance: of the applicant, employer, evaluator, third party, or similar data variables. In another embodiment of the present invention, the guarantee amount 408 can be decided by the third party evaluators who post the job requirement on behalf of any organization and evaluate the candidates for the organization without departing from the spirit or scope of the invention.

In an embodiment of the present invention, the GUI 400 further comprises of past application history 410 that can provide information about the history of job postings and the applications submitted. On the GUI 400 of the hiring managers, the past application history can comprise of the information such as, but not limited to: job requirements posted by the hiring manager, number of applications received, number of successful and unsuccessful applications, number of candidates communicated after successful evaluation of the application and the like. In another embodiment, the GUI 400 of the candidate can comprise of information such as, but not limited to, number of job postings viewed, number of job postings applied, number of successful and unsuccessful selections of the application, guarantee amount paid, guarantee amount forfeited, status of the communication with the hiring managers and the like.

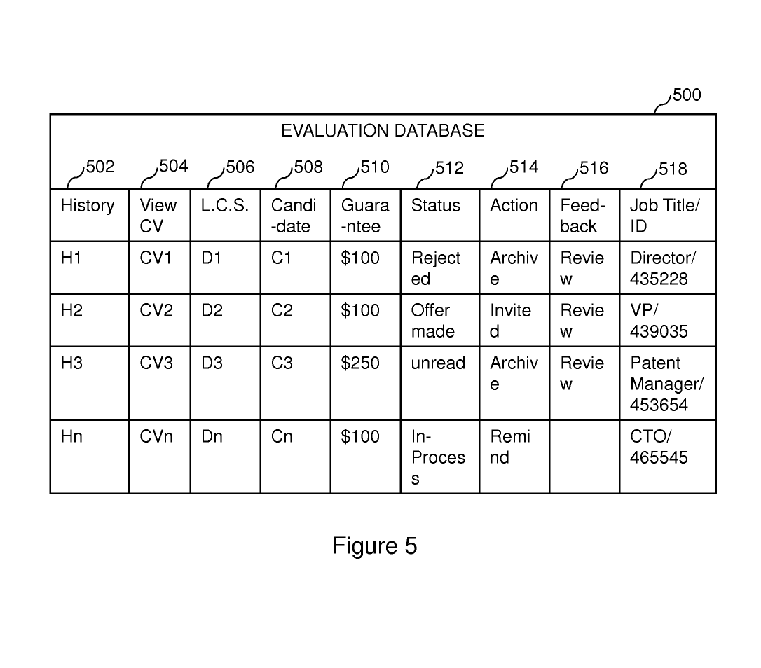

In an embodiment of the present invention, the assertion system can manage displaying of the selected and related information to the hiring managers and the candidates on the respective GUIs without departing from the scope of the present invention. FIG. 5 illustrates an exemplary evaluation database that may be displayed on the GUI of the hiring manager.

FIG. 5 is a schematic table 500 illustrating an exemplary evaluation database for storing evaluation data, according to an embodiment of the present disclosure. The evaluation database comprises of the information related to various job postings posted on the website by an evaluator or hiring manager and the history related to it. The evaluation table comprises of the information such as history 502 of the job posting, information corresponding to curriculum vitae's (CV) 504 received for the job posting, Last Status Change (LCS) 506 including date corresponding to the latest change made in the status of the job, candidate details 508 received for the job posting, guarantee amount 510, status 512 of the application, action taken 514 by the hiring manager, feedback 516 of the hiring manager, and job title/job ID 518 for which the job posting is posted.

Consider an example, of the history 502 for H1, for which the job posting is posted by the hiring manager. The job posting with history H1 comprises of the CV1 that can be viewed by the hiring manager. Further, the Last status Change (LCS) includes the date D1 when the last modification was performed corresponding to the job posting for which the candidate C1 applied with a guarantee amount of $100. The status of the job posting with history H1 is displayed as rejected, action taken by the hiring manager is displayed as archived, feedback to be given by the hiring manager is ready for ‘review’. The job title/ID is displaying as ‘Director’/435228.

In an embodiment of the present invention, one or more entries and values entered in the various columns can be actionable (e.g. hyperlinked) such that upon clicking on the actionable elements the user can be presented with additional information. For example, the CV column in the evaluation table can be hyperlinked such that upon clicking on the CV of the particular applicant, the CV of the applicant can be viewed by the hiring manager. In a similar way one or more of the values can be actionable in the evaluation table, without departing from the scope of the invention.

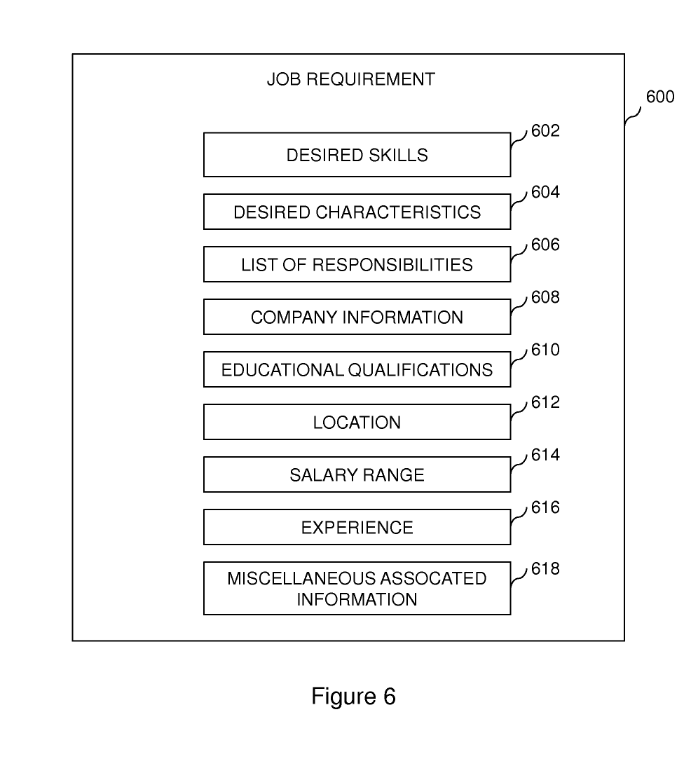

FIG. 6 is an exemplary block diagram for job description requirement 600, according to an embodiment of the present disclosure. The job description provides information corresponding to a new job opening for which an employer may be seeking applications from various candidates. As depicted, the ‘job description’ 600 may include ‘desired skills’ 602, ‘desired characteristics’ 604, ‘list of responsibilities’ 606, ‘company information’ 608, ‘educational qualifications’ 610, ‘location’ 612, ‘salary range’ 614, ‘experience’ 616, and ‘miscellaneous associated information’ 618.

The ‘desired skills’ 602 may include skills required for a particular job posting. Further, ‘desired characteristics’ 604 correspond to characteristics of the candidate that are required for the particular job opening. Furthermore, ‘list of responsibilities’ 606 may include, but not limited to, one or more roles and duties that may be required to perform by the selected candidate during his/her job. Again further, ‘company information’ 608 may include the information corresponding to the company where the candidate may be located once he is selected for any job opening. In an embodiment, the ‘company information’ 608 may include information corresponding to a third party's company that may act as an agent between the organization, where the candidate will be located, and the candidate.

Further, ‘educational qualifications’ 610 may correspond to the required qualification with respect to education of the suitable candidate. Additionally, the job description 600 may include ‘location’ 612 of job i.e., the location where the candidate may be appointed for a particular job once the candidate is selected. ‘Salary range’ 614 describes a range of salary (or Cost To Company) that may be offered to the selected candidate upon successful hiring corresponding to the job description and to perform roles and responsibilities corresponding to the particular job. Also, ‘experience’ 616 may refer to desired past working exposure of the candidate and it may include corresponding experience information of the candidate. For example, the ‘experience’ may include the organization information where the candidate has worked earlier and the duration for which the candidate has worked in the past in one or more organizations.

Further, the job description 600 may not be restricted to above mentioned information. Further, the job description 600 may include ‘miscellaneous associated information’ 618. It may be appreciated by a person skilled in the art that the job description may include one or more other information.

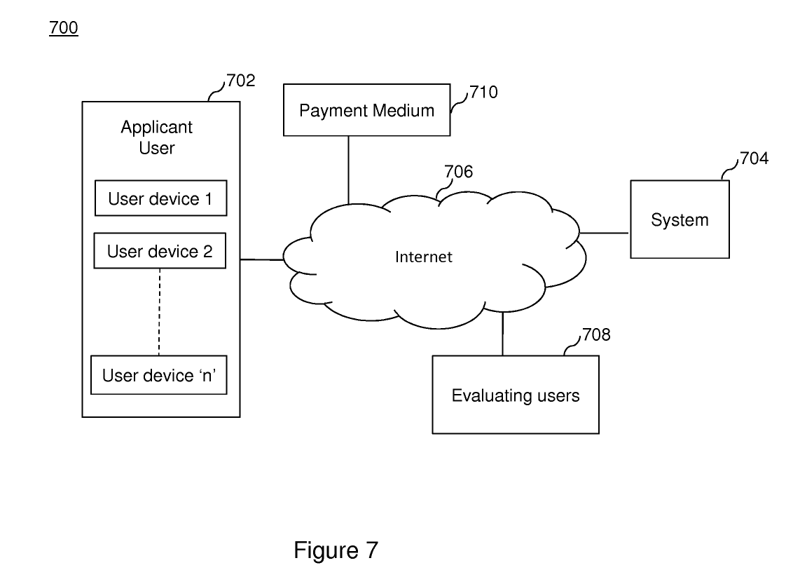

FIG. 7 depicts a network architecture illustrating a system for evaluating user assertions of suitability, according to another embodiment of the present disclosure. As shown, the network 700 comprises of users 702, a system 704, an internet 706, an evaluating user 708, and a payment medium 710. The users 302 can comprise of one or more users as depicted from user device 1, user device 2, . . . user device ‘n’ that are submitting applications.

The architecture further comprises of the evaluating users 708 who are posting the requirements on a website so that applicants can see the posting and apply for the requirements. In an embodiment of the present invention, the evaluating users can be accessing the device from their location and can post the requirement on the website. In an alternate embodiment, the requirements can be posted by another user on behalf of an evaluating user. The network architecture 700 can further comprise of the system 704 that can perform receiving the requirements and the application along with the guarantee, authenticating the guarantee, evaluating the application and providing an outcome to the evaluating user about the evaluation of the application. The users 702 can communicate with the system 704 via Internet 706. Further, in an embodiment, the user 702 may be facilitated to interact with evaluating users 708 directly through the Internet 706. Additionally, in an embodiment, the applicant user 702 may be allowed to interact with payment medium to provide guarantee amount that may be modified based on the suitability of the application of the user 702 with respect to the requirements.

In another embodiment of the present invention, the system 704 can be part of the evaluating users 708. In yet another embodiment of the present invention, the system 704 may be a part of a third party, such as a headhunter agency that can interact with the hiring managers 708.

According to the an embodiment of the present invention, the evaluating users 708, or another user on their behalf, can post a requirement for a job on the website over the Internet 706 and that can be presented to users 702 through the system 704. The users 702 can view the job requirement posted. Upon finding that their qualification is suitable for the job requirement, the users 702 can submit their assertion along with a guarantee to the system 704 over the network, such as (but not limited to) Internet 706. The payment medium 710 can authenticate the guarantee and once the system 704 receives the acknowledgement from the payment medium 710, the evaluation of the application can be initiated. The evaluation of the application has been described previously in conjunction with FIGS. 1-7 and thus not repeated herein again for the sake of brevity.

Advantageously, the present invention provides an efficient way of evaluating the applications wherein the applicant asserts his/her suitability with respect to a particular requirements posting. Based on the method and system of evaluating the user's assertion, applicants are more selective towards submitting an application. In other words, the applicant will be more industrious prior to applying for the requirements by submitting a guarantee. Due to this, the burden on the evaluator in pursuing irrelevant, and unsuitable applications may be reduced. Further, at least a portion of the guarantee amount may be refunded based on the suitability matching of the candidate's application. Due to this, the applicant may be refunded at least a portion of the guaranteed money in case the applicant does not reach to the round of selection by the evaluator or hiring manager.

The present embodiments have been described with reference to specific example embodiments; it will be evident that various modifications and changes may be made to these embodiments without departing from the broader spirit and scope of the various embodiments. Furthermore, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium.

Although the embodiments herein are described with various specific embodiments, it will be obvious for a person skilled in the art to practice the invention with modifications. However, all such modifications are deemed to be within the scope of the claims. It is also to be understood that the following claims are intended to cover all of the generic and specific features of the embodiments described herein and all the statements of the scope of the embodiments which as a matter of language might be said to fall there between.

What is claimed is:

1. A computer-implemented method for evaluating user assertions of suitability, the method comprising:
receiving an application along with a guarantee from an applicant, the application being received in response to one or more requirements;
evaluating the suitability of the application with respect to the one or more requirements;
determining the outcome of the evaluation of the application with respect to the one or more requirements; and
modifying the guarantee received based on the outcome of the evaluation of the application.

2. The method of claim 1, wherein the guarantee received from the applicant:
is one or more of monetary, commodity, bitcoin, service, virtual currency, loyalty program, reward points, and
the guarantee amount is determined algorithmically.

3. The method of claim 1, wherein modifying the guarantee comprises of at least one of:
forfeiting a portion of the guarantee when the outcome of the evaluation determines non-matching of the application with the one or more requirements, and
reducing a portion of the guarantee when the application does match with the one or more requirements.

4. The method of claim 1 further comprising:
rewarding at least one of applicant, evaluator, and user assertion service if a successful match is determined.

5. The method of claim 1 further comprising of:
enabling at least one of the applicant and the evaluator to be able to rate the other, and the entity represented by the other.

6. The method of claim 1 further comprises storing the determined outcome of the evaluation of the applications with respect to the one or more requirements.

7. A system for evaluating user assertions of suitability comprising:
a processor that processes a document hosted on an internet connected server;
a receiver module for receiving an application along with a guarantee from a candidate device, the application being received in response to one or more requirements;
an evaluation module for evaluating the suitability of the application with respect to the one or more requirements;
the evaluation module determines the outcome of the application with respect to the one or more requirements;
a deduction module configured for modifying the guarantee received based on the outcome of the evaluation of the application; and
a memory for storing the application.

8. The system of claim 7 further comprises at least one of:
a guarantee verification module for authenticating the guarantee received from the applicant device, wherein the guarantee received from the applicant device is of one or more type of: monetary, commodity, bitcoin, service, virtual currency, loyalty program, reward points, and
the guarantee amount is determined algorithmically.

9. The system of claim 7, wherein the deduction module modifies the guarantee by at least one of:
forfeiting a portion of the guarantee when the outcome of the evaluation determines non-matching of the application with the one or more requirements, and
deducting a portion of the guarantee when the application does match with the one or more requirements.

10. The system of claim 7, wherein the system enables additional communication with an applicant device when the evaluation determines matching of the application with the requirements.

11. The system of claim 7 further comprising:
rewarding at least one of applicant, evaluator, and user assertion service if a successful match is determined.

12. The system of claim 7 further comprising:
enabling at least one of the applicant and the evaluator to be able to rate the other, and the entity represented by the other.

13. The system of claim 7 further comprising:
storing the determined outcome of the evaluation of the application with respect to the one or more requirements in the memory.

14. A computer-program product for evaluating user assertions, the computer-program product comprising a non-transitory computer-readable medium having instructions thereon, when executed enables an assertion system to perform the steps of:
receiving an application along with a guarantee from an applicant, the application being received responsive to one or more requirements;
evaluating the suitability of the application with respect to the one or more requirements;
determining the outcome of the evaluation of the application with respect to the one or more requirements; and
modifying the guarantee received based on the outcome of the evaluation of the application.

15. The computer-program product of claim 14, wherein the guarantee received from the applicant device
is of one or more type of: monetary, commodity, bitcoin, service, virtual currency, loyalty program, reward points, and
the guarantee amount is determined algorithmically.

16. The computer-program product of claim 14, wherein modifying the guarantee comprises at least one of:
forfeiting a portion of the guarantee when the outcome of the evaluation determines non-matching of the application with the one or more requirements, and
deducting a portion of the guarantee when the application does match with the one or more requirements.

17. The computer-program product of claim 14 further comprising enabling additional communication between the evaluator and the applicant when the evaluation determines matching of the application with the one or more requirements.

18. The computer-program product of claim 14 further comprising of rewarding at least one of applicant, evaluator and user assertion service if a successful match is determined.

19. The computer-program product of claim 14 further comprising enabling at least one of the applicant and the evaluator to be able to rate the other.

20. The computer-program product of claim 14 further comprising a step of storing the determined outcome of the evaluation of the applications with respect to the one or more requirements.
